(19) United States
(12) Patent Application Publication
(10) Pub. No.: US 2008/0308705 A1
(43) Pub. Date: Dec. 18, 2008

(54) Clamping Assemblies

(76) Inventors: Matthew Alexander Robert Sharp, Bishop's Stortford (GB); Dean Stephen Hartley, Wakefield (GB)

Correspondence Address: BARNES & THORNBURG LLP, P.O. BOX 2786, CHICAGO, IL, 60690-2786, US

(21) Appl. No.: 11/779,051

(22) Filed: Jul. 17, 2007

(30) Foreign Application Priority Data
Jun. 15, 2007 (GB) 0711617.1

(51) Int. Cl. F16M 13/00

(52) U.S. Cl. 248/544

(57) ABSTRACT

A clamping assembly (4) realisably clamps a component, such as a loudspeaker (1) in an aperture (2) in a panel such as a ceiling panel (3). The clamping assembly (4) has a guide (5) for attachment to the component, and a clamping member (13; 13a; 113) slideable within the guide. Rotation of a threaded member (23) causes sliding movement of the clamping member (13; 13a; 113) relative to the guide (5) either in a first direction for clamping the component to the panel or in a second direction for releasing the component from the panel. The guide and the clamping member are co-operatively shaped so that movement of the clamping member in the first direction to achieve clamping rotates the clamping member with respect to the guide from a non-clamping position to a clamping position and movement of the clamping member in the second direction to achieve release rotates the clamping member with respect to the guide from the clamping position to the non-clamping position.

### FIELD OF THE INVENTION

This invention relates to clamping assemblies for clamping components in apertures in panels, and particularly to clamping assemblies for clamping audio loudspeakers above apertures in ceiling panels.

### BACKGROUND TO THE INVENTION

Conventionally, a ceiling loudspeaker is mounted above a circular aperture cut in a ceiling panel, typically of plasterboard. The loudspeaker is inserted upwardly through the aperture and clamping screws are passed upwardly through a bezel plate and threaded in “dog leg” clamping members which are initially in a withdrawn position (to enable them to pass upwardly through the aperture) and then, under the influence of the screw being thread into the clamping member, are rotated through approximately 90° so that one end of the clamping member projects beyond the outline of the aperture, enabling the clamping member to be clawed against the ceiling panel as the screw is tightened.

Sometimes the clamping members do not rotate satisfactorily to their clamping positions, or (more commonly) do not rotate to their release positions when the screws are released, because in both cases rotation of the clamping members relies on the frictional properties of the screws and the clamping members. Releasing movement of the clamping members can also be impeded as a consequence of the clamping members digging into the comparatively soft plasterboard. This makes removal of the speakers for servicing or replacement very difficult. The invention aims to provide a clamping assembly in which the desired rotation of the clamping member is assured.

### SUMMARY OF THE INVENTION

According to the invention a clamping assembly for clamping a component in an aperture in a panel comprises a guide for attachment to the component and a clamping member slidable within the guide under the control of a threaded member rotation of which causes the clamping member to undergo sliding movement with respect to the guide either in a first direction for clamping the component to the panel or in a second direction for release of the component from the panel, wherein the guide and the clamping member are co-operatively shaped so that movement of the clamping member in the first direction to achieve clamping rotates the clamping member with respect to the guide from a non-clamping position to a clamping position and movement of the clamping member in the second direction to achieve release rotates the clamping member within respect to the guide from the clamping position to the non-clamping position.

Thus, the co-operative shaping of the guide and the clamping member ensures that the latter undergoes the desired rotational movement, both on tightening and releasing of the treaded member and also ensures that unwanted rotational movement of the clamping member is prevented.

The clamping member may have a boss-like end slidable in the guide which is then of complementary part-cylindrical shape. The boss-like end of the clamping member may be formed with a hole to receive the threaded member which preferably forms a self-tapping thread in the boss as the threaded member is advanced. The threaded member is preferably a screw which is passed through a bezel or the like before being threaded into the boss.

The other end of the clamping member preferably has a projecting formation for engagement with the panel surface adjacent to the edge of the aperture, the formation lying within the area of the aperture when the clamping member is in the non-clamping position and the formation projecting beyond the area of the aperture when the clamping member is in the clamping position.

In the preferred embodiment, the formation comprises three spaced feet to spread the clamping pressure over a substantial area of the plasterboard, to minimise the risk of damage to the latter. The surfaces of the feet are preferably provided with projecting dimples to aid firm engagement of the feet against the panel.

In order to rotate the clamping member from the non-clamping position to the clamping position, one side of the guide preferably has a projecting wall with a convex curved edge which engages, in the manner of a cam, with a concave surface on the clamping member, these surfaces being brought into engagement as the threaded member is tightened with attendant movement of the clamping member in the first direction.

In order to rotate the clamping member from the clamping position to the non-clamping position, the other side of the guide preferably has a projecting wall which engages, in the manner of a cam, with a curved edge on the clamping member, these surfaces being brought into engagement as the threaded member is released with attendant movement of the clamping member in the second direction.

The invention was devised to clamp a ceiling loudspeaker in a circular aperture in a ceiling panel, normally a plasterboard panel. For this purpose, three clamping assemblies have been found to be sufficient (in contrast to conventional arrangements which employ four dog-leg clamping members) because of the greater reliability of the clamping action, the greater surface area of the clamping feet and the dimpling of the latter which provides a firm clamping action without undue distortion of the comparatively soft plasterboard. Thus, in the preferred embodiment the loudspeaker mounting has three guides each provided with a corresponding clamping member which is initially in the non-clamping position to enable the loudspeaker and its mounting to be passed upwardly through the circular aperture in the ceiling panel. Three screws are passed upwardly trough an annular bezel and screwed into the respective bosses of the clamping members which, as they are drawn downwardly in the guides, are automatically rotated through about 90° to their clamping positions in which they are then retained and in which the outer ends of the clamping members project beyond the outline of the circular aperture. Further tightens of the screws clamps the outer ends of the clamping members against the upper surface of the plasterboard, so as firmly to retain the loudspeaker in position above the aperture in the ceiling panel. If it is desired to remove the loudspeaker (for servicing or replacement), the screws are rotated in the releasing direction, causing the clamping members to move upwardly in the guides and automatically rotate from the clamping to the non-clamping positions in which they are then retained.

The invention includes within its scope a loudspeaker provided with a mounting having a plurality, preferably three, clamping assemblies, each in accordance with the invention.

### BRIEF DESCRIPTION OF THE DRAWINGS

A clamping assembly acing to the invention will now be described, by way of example, with reference to the accompanying drawings in which:

FIG. 1 is an isometric view of one of three clamping assemblies used to secure a loudspeaker with respect to a ceiling panel,

FIG. 2 is a plan view of the loudspeaker and clamping assemblies, prior to clamping thereof,

FIG. 3 is an isometric view of a clamping member of the clamping assembly,

FIG. 4 is an isometric view of a modified form of clamping member,

FIG. 5 is an elevational view of the underside of another modified clamping member,

FIGS. 6 and 7 are side and end elevations respectively of the clamping member of FIG. 5,

FIG. 8 is a sectional view taken along the line B-B of FIG. 6, and

FIG. 9 is an isometric view of the modified clamping member shown in FIGS. 5 to 8.

### DETAILED DESCRIPTION OF THE DRAWINGS

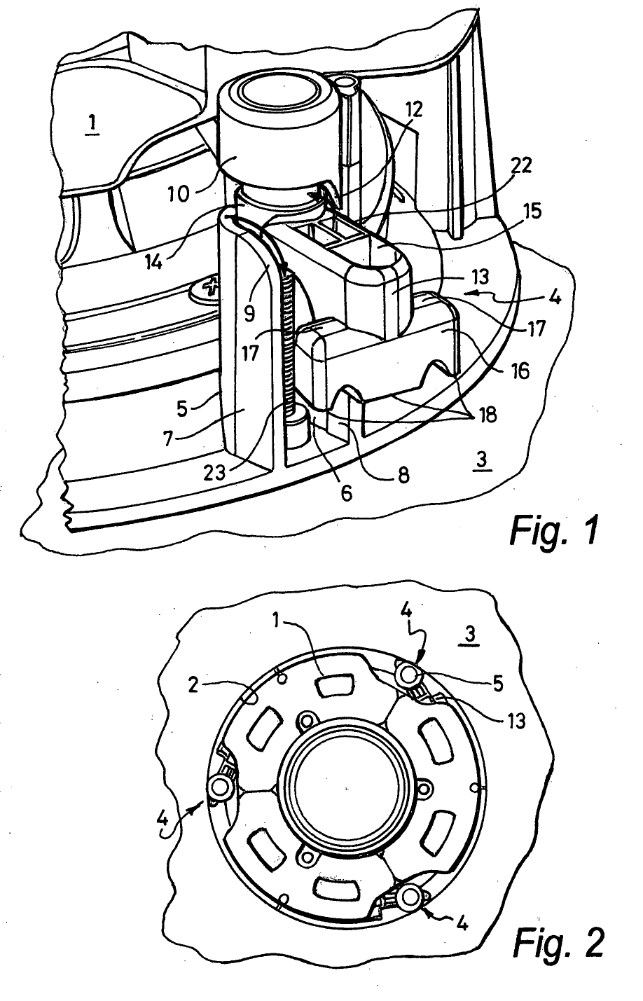

Referring to FIGS. 1 and 2, an audio loudspeaker 1 is secured above a circular aperture 2 in a horizontal ceiling panel 3 of plasterboard at three equi-angularly spaced positions by three identical clamping assemblies 4, one of which is shown to an enlarged scale in FIG. 1. This clamping assembly 4 will now be described with reference to FIGS. 1, 2 and 3.

The clamping assembly 4 comprises a guide 5 moulded from a synthetic plastics material so as to present a vertically elongaged part-cylindrical slot 6 flanked by side walls 7 and 8. One side wall 7 has a convex upper edge 9 and the other side wall 8 adjoins a cap 10 and has a smoothly curved concave wall 12.

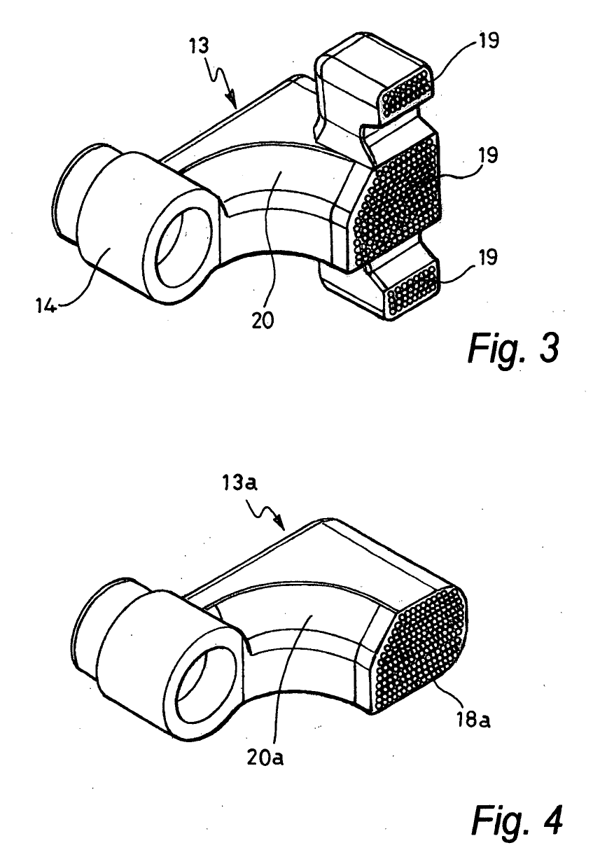

A clamping member 13 moulded from a plastics material has a boss-like inner end 14 slideable in the slot 6, an intermediate portion 15 projecting outwardly from the slot 6 and an outer end 16 having projecting shoulders 17. The underside of the outer end has two slots defining three pad-like feet 18 the undersides of which are moulded with pimples 19 (FIG. 3) for gripping the upper surface of the plasterboard ceiling panel 3.

The lower edge of one side of the intermediate portion of the clamping member has a smoothly curved concave surface 20 (FIG. 3) and the upper edge of the other side of the intermediate portion of the clamping member has a smoothly curved convex edge 22. The edge 9 co-operates with the surface 20 and the wall 12 co-operates with the edge 22 in the following manner.

When mounting the loudspeaker in position, the boss 14 is inserted in the guide slot 6 and a screw 23 is passed, from below, through a hole in an annular bezel plate (not shown) and is pushed into the central hole in the boss 14. At this stage, each clamping member is in the non-clamping position where the whole of the clamping member 13 is within the circular area of the aperture 2, as shown in FIG. 2. As the screw 23 is tightened, it cuts a thread in the plastics boss 14 and draws the clamping member 13 downwardly through the slot 6. This brings the edge 9 into contact with the surface 20, causing the clamping member 13 to rotate in the slot to the clamping position shown in FIG. 1. Thereafter, continued rotation of the screw 23 draws the clamping member 13 downwardly to bring the feet 18 into firm engagement with the upper surface of the ceiling panel 3, the walls 7 and 8 maintaining the member 13 in the projecting clamping position. Because each clamping member 13 has three feet 18, there are nine areas of the plasterboard ceiling panel which are clamped.

If it is required to release the loudspeaker, rotation of the screw 23 in the opposite, i.e. releasing, direction causes the clamping member 13 to slide upwardly in the slot 6 until the wall 12 engages the edge 22, causing the clamping member 13 to rotate in the slot 6 so as to ret the clamping member to the release or non-clamping position (FIG. 2) in which the clamping member 13 is maintained by the shaping of the guide 5.

The modified form of clamping member 13a shown in FIG. 4 is similar to that shown in FIG. 3, having a surface 20a corresponding to the surface 20 and an edge corresponding to the edge 22, but the clamping member of FIG. 4 does not have the projecting shoulders and side feet, having merely one dimpled foot 18a for clamping engagement with the plasterboard ceiling panel 3.

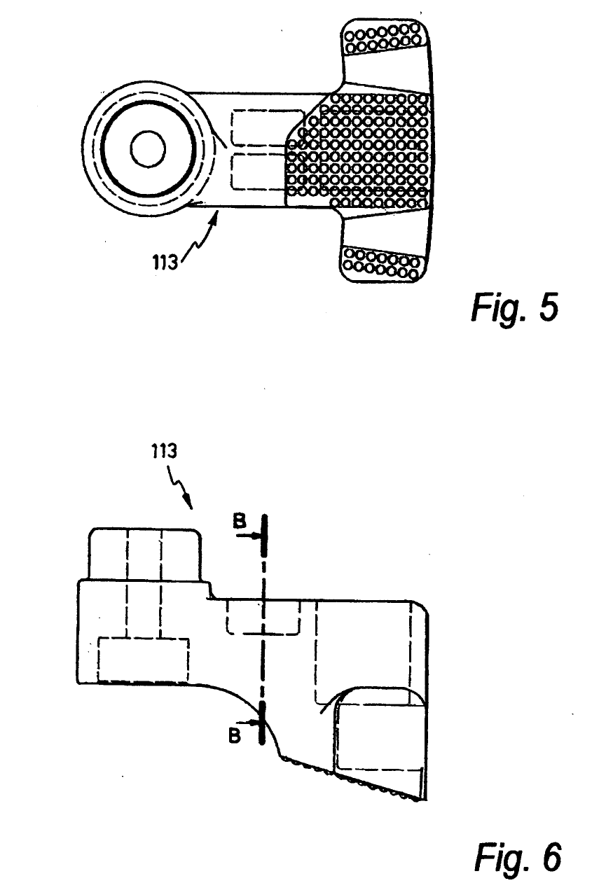

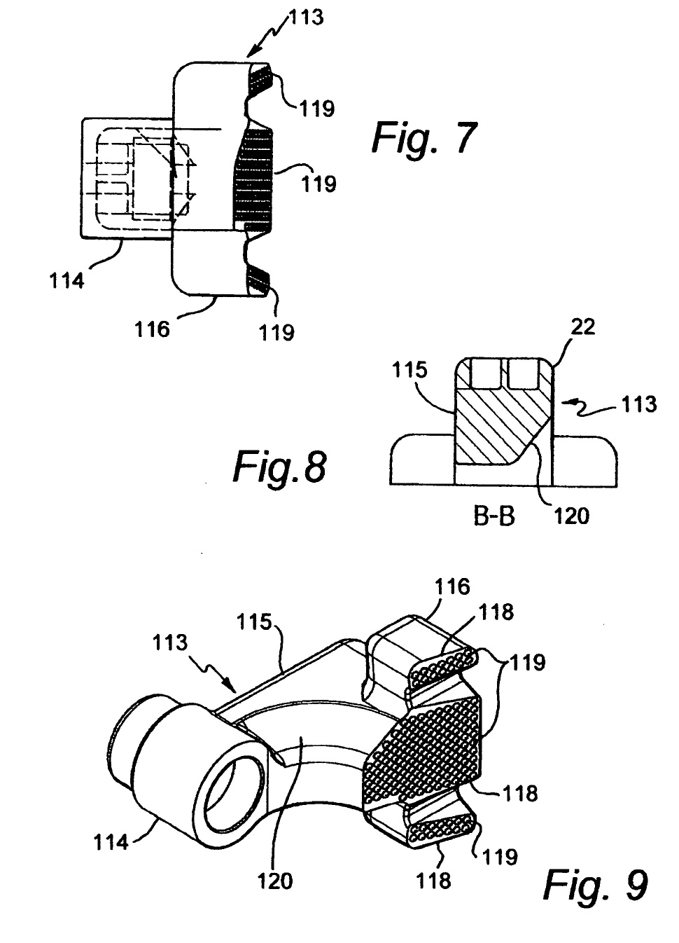

The clamping member 113 shown in FIGS. 5-19 is identical in many respects to the clamping member 13, and corresponding parts are therefore denoted by the reference numerals of FIGS. 1-3, raised by 100.

The clamping member 113 differs from the clamping 13 in that its feet 118 are angled towards the boss 114, so that the radial outer edge of each foot is lower than the inner edge, with the clamping member in its normally intended altitude of use. The angling of the feet enables the plasterboard to be more effectively engaged, the feet providing improved resistance to lateral movement of the clamped speaker.

The clamping member 113, in use, is slidably mounted in the same type of guide 5 as is shown in FIG. 1, and co-operates with the guide in the same way as does the clamping member 13.

1-14. (canceled)

15. A clamping assembly for clamping a component in an aperture in a panel, comprising a guide for attachment to the component and a clamping member slidable within the guide under the control of a threaded member rotation of which causes the clamping member to undergo sliding movement with respect to the guide either in a first direction for clamping the component to the panel or in a second direction for release of the component from the panel, wherein the guide and the clamping member are co-operatively shaped so that movement of the clamping member in the first direction to achieve clamping rotates the clamping member with respect to the guide from a non-clamping position to a clamping position and movement of the clamping member in the second direction to achieve release rotates the clamping member with respect to the guide from the clamping position to the non-clamping position.

16. A clamping assembly according to claim 15, in which the clamping member has a boss-like end slidable in the guide which is then of complementary part-cylindrical shape.

17. A clamping assembly according to claim 16, in which the boss-like end of the clamping member is formed with a hole to receive the threaded member.

18. A clamping assembly according to claim 17, in which the threaded member forms a self-tapping thread in the boss as the threaded member is advanced.

19. A clamping assembly according to claim 15, in which the threaded member is a screw which is passed through a through a bezel or the like before being threaded into the boss.

20. A clamping assembly according to claim 16, in which the other end of the clamping member has a projecting formation for engagement with the panel surface adjacent to the edge of the aperture, the formation lying within the area of the aperture when the clamping member is in the non-clamping position and the formation projecting beyond the area of the aperture when the clamping member is in the clamping position.

21. A clamping assembly according to claim 20, in which the formation comprises three spaced feet to spread the clamping pressure over a substantial area of the plasterboard, to minimise the risk of damage to the latter.

22. A clamping assembly according to claim 21, in which the surfaces of the feet are provided with projecting pimples to aid firm engagement of the feet against the panel.

23. A clamping assembly according to claim 15, in which, in order to rotate the clamping member from the non-clamping position to the clamping position, one side of the guide has a projecting wall with a convex curved edge which engages, in the manner of a cam, with a concave surface on the clamping member, these surfaces being brought into engagement as the threaded member is tightened with attendant movement of the clamping member in the first direction.

24. A clamping assembly according to claim 23, in which in order to rotate the clamping member from the clamping position to the non-clamping position, the other side of the guide has a projecting wall which engages, in the manner of a cam, with a curved edge on the clamping member, these surfaces being brought into engagement as the threaded member is released with attendant movement of the clamping member in the second direction.

25. A loudspeaker provided with a mounting having a plurality of clamping assemblies in accordance with claim 15.

26. A loudspeaker according to claim 25, in which the loudspeaker has three clamping assemblies.
